(19) United States
(12) Patent Application Publication
(10) Pub. No.: US 2023/0056409 A1
(43) Pub. Date: Feb. 23, 2023

(54) TRANSMISSION POWER CONTROL COMMAND FOR A GROUP OF COMPONENT CARRIERS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 17/794,916

(22) PCT Filed: Jan. 15, 2021
(86) PCT No.: PCT/CN2021/072045

§ 371 Date: Jul. 22, 2022

(30) Foreign Application Priority Data
Jan. 23, 2020 (CN) PCT/CN2020/074010

(51) Int. Cl. H04W 52/58

(52) U.S. Cl. CPC H04W 52/58

(57) ABSTRACT

Aspects of the disclosure relate to a method of wireless communication that includes a scheduling entity formatting a message, to convey a TPC command to be implemented at a plurality of cells and transmitting the message to a scheduled entity. Other aspects relate to a method of wireless communication that includes the scheduled entity receiving a message conveying a TPC command to be implemented at a plurality of cells and applying the TPC command to the plurality of cells. Other aspects and features are also claimed and described.

### PRIORITY CLAIM

This application claims priority to and the benefit of Patent Cooperation Treaty Application No, PCT/CN 2020/074010, filed in the Peoples Republic of China with the Chinese National Intellectual Property Administration on Jan. 23, 2020, the entire content of the prior application is incorporated herein by reference as if fully set forth below in its entirety and for all applicable purposes.

### TECHNICAL FIELD

The technology discussed below relates generally to wireless communication systems, and more particularly, to a transmission power control (TPC) command for a group of cells (e.g., carriers, component carriers).

### INTRODUCTION

The radio spectrum is limited and must be shared by multiple service providers, each of whom rely on radio access networks with multiple scheduling entities (e.g., network access nodes, eNBs, gNBs) to communicate with a vast number of user devices. According to some aspects, a scheduling entity may communicate with a scheduled entity to coordinate scheduling and numerous control items. Among these control items are transmitter power control. Implementation of cross-carrier scheduling may have improved the use of the spectrum; however, attending to transmitter power control of numerous primary and secondary cells using conventional transmitter power control procedures remains inefficient.

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example a method of wireless communication implementing, operational at a scheduling entity, is disclosed. The method includes formatting a message to convey a transmitter power control (TPC) command to be implemented at a plurality of cells and transmitting the message to a scheduled entity. According to one aspect, an apparatus for wireless communication is disclosed. The apparatus includes means for formatting a message to convey a TPC command to be implemented at a plurality of cells and means for transmitting the message to a scheduled entity. In another aspect, a non-transitory computer-readable medium storing computer-executable code is disclosed. According to one example, the code causes a computer to format a message to convey a TPC command to be implemented at a plurality of cells and transmit the message to a scheduled entity. In still another aspect, an apparatus for wireless communication is disclosed. the apparatus includes a processor, a transceiver communicatively coupled to the one processor, and a memory communicatively coupled to the processor. In one example, the processor is configured to format a message to convey a TPC command to be implemented at a plurality of cells and transmit the message to a scheduled entity.

In another example a method of wireless communication, operational at a scheduled entity, is disclosed. The method includes receiving a message conveying a TPC command to be implemented at a plurality of cells and applying the TPC command to the plurality of cells. In one aspect, an apparatus for wireless communication is disclosed. The apparatus includes means for receiving a message conveying a TPC command to be implemented at a plurality of cells and means for applying the TPC command to the plurality of cells. In another aspect, a non-transitory computer-readable medium storing computer-executable code is disclosed. According to one example, the code causes a computer to receive a message conveying a TPC command to be implemented at a plurality of cells and apply the TPC command to the plurality of cells. In another example, an apparatus for wireless communication is disclosed. The apparatus includes a processor, a transceiver communicatively coupled to the processor, and a memory communicatively coupled to the processor. In one example the processor is configured to receive a message conveying a TPC command to be implemented at a plurality of cells and apply the TPC command to the plurality of cells.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a conceptual illustration of an example of a radio access network according to some aspects of the disclosure.

FIG. 3 is a block diagram illustrating an example of a wireless communication system supporting multiple-input multiple-output (MIMO) communication.

FIG. 4 is a schematic illustration of an organization of wireless resources in an air interface utilizing orthogonal frequency divisional multiplexing (OFDM) according to some aspects of the disclosure.

FIG. 5 is a schematic illustration of an OFD. air interface utilizing a scalable numerology according to some aspects of the disclosure.

FIG. 6 is a block diagram conceptually illustrating an example of a hardware implementation for a scheduling entity employing a processing system according to some aspects of the disclosure.

FIG. 7 is a block diagram conceptually illustrating an example of a hardware implementation for a scheduled entity according to some aspects of the disclosure.

FIG. 8 depicts a call flow diagram between a scheduling entity (e.g., a network access node, a gNB, and eNB) and a scheduled entity (e.g., a user equipment, user device, mobile device) according to some aspects of the disclosure.

FIG. 9 depicts a second call flow diagram between a scheduling entity (e.g., a network access node, a gNB, and eNB) and a scheduled entity (e.g., a user equipment, user device, mobile device) according to sonic aspects of the disclosure.

FIG. 10 depicts a third call flow diagram between a scheduling entity (e.g., a network access node, a gNB, and eNB) and a scheduled entity (e.g., a user equipment, user device, mobile device) according to some aspects of the disclosure.

FIG, 11 is a flow chart illustrating an exemplary process for wireless communication, operational at a scheduling entity, according to some aspects of the disclosure.

FIG. 12 is a second flow chart illustrating an exemplary process for wireless communication, operational at a scheduling entity according to some aspects of the disclosure.

FIG. 13 is a flow chart illustrating an exemplary process for wireless communication, operational at a scheduled entity, according to some aspects of the disclosure.

FIG. 14 is a second flow chart illustrating an exemplary process for wireless communication, operational at a scheduled entity, according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to sonic examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e,g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

Various aspects described herein relate to dynamic spectrum sharing (DSS). DSS may provide opportunities to enhance aspects related to the physical downlink control channel (PDCCH) in connection with cross-carrier scheduling. The enhancements may include, for example, utilizing a PDCCH of a primary cell (PCell) a primary component carrier, a primary carrier) or a secondary cell (SCell) (e.g., a secondary component carrier, a secondary carrier) to schedule a physical uplink shared channel (PUSCH) and/or a physical uplink control channel (PUCCH), for example, of a PCell or another SCell. In more detail, aspects described herein may relate to a use of a PDCCH of a PCell or SCell to schedule PUSCH and/or PUCCH on multiple cells (e.g., multiple component carriers) using a single downlink control information (DCI). The single DCI may convey timing restrictions to at least one of control or prevent UL transmitter power fluctuation within one uplink transmission.

Aspects described herein may additionally or alternatively relate to the use of a transmission power control (TPC) command to control power for a group of component carriers. A TPC command may be applied to one component carrier (CC) (also referred to herein as a cell or a carrier). According to aspects described herein, a TPC command may be applied to multiple CCs, (referred to herein as a multi-CC TPC command), For each multi-CC TPC command, a network access node (e.g., a scheduling entity, a gNB, an eNB) may indicate applicable CCs.

According to one aspect, the applicable CCs may be explicitly indicated. Explicit indication may be made, for example, in radio resource control (RRC) message, a medium access control-control element (MAC-CE), or a downlink control information (DCI). The preceding list is exemplary and non-limiting.

According to one aspect, an associated CC group ID may indicate applicable CCs. In case that the DCI carries multiple multi-CC TPC commands, a network access node (e.g., a scheduling entity, a gNB, an eNB) may indicate a CC group ID per command, for example, group ID 1 for 1st TPC command, group ID 2 for 2nd TPC command, etc.

The CC group ID may or may not be signaled in the DCI carrying multi-CC TPC command. According to one aspect, applicable CCs may be indicated by corresponding CC IDs or bits in a bitmap.

According to another aspect, applicable CCs maybe implicitly indicated. For example, a multi-CC TPC command may be applied to all CCs scheduled by a single DCI. According to some aspects, the DCI may indicate each multi-CC TPC command to be applied to a particular uplink (UL) channel type, e.g., PUSCH/PUCCH/SRS/PRACH. The preceding list is exemplary and non-limiting,

### DEFINITIONS

RAT: radio access technology. The type of technology or communication standard utilized for radio access and communication over a wireless air interface. Just a few examples of RATs include GSM, UTRA, E-UTRA (LIE), Bluetooth, and Wi-Fi.

NR: new radio. Generally refers to 5G technologies and the new radio access technology undergoing definition and standardization by 3GPP in Release 15.

Legacy compatibility: may refer to the capability of a 5G network to provide connectivity to pre-5G devices, and the capability of 5G devices to obtain connectivity to a pre-5G network.

Multimode device: a device that can provide simultaneous connectivity across different networks, such as 5G, 4G, and networks.

CA: carrier aggregation. 5G networks may provide for aggregation of sub-6 GHz carriers, above-6 GHz carriers, mmWave carriers, etc., all controlled by a single integrated MAC layer.

MR-AN: multi-RAT radio access network, A single radio access network may provide one or more cells for each of a plurality of RATs and may support inter- and intra-RAT mobility and aggregation.

MR-CN: multi-RAT core network. A single, common core network may support multiple RATs (e.g., 5G, LTE, and WLAN). in some examples, a single 5G control plane may support the user planes of a plurality of RATs by utilizing software-defined networking (SDN) technology in the core network.

SDN: software-defined networking, A dynamic, adaptable network. architecture that may be managed by way of abstraction of various lower-level functions of a network, enabling the control of network functions to be directly programmable.

SDR: software-defined radio. A dynamic, adaptable radio architecture where many signal processing components of a radio such as amplifiers, modulators, demodulators, etc. are replaced by software functions. SDR enables a single radio device to communicate utilizing different and diverse waveforms and RATs simply by reprogramming the device.

mmWave: millimeter-wave. Generally refers to high hands above 24 GHz, ch can provide a very large bandwidth.

Beamforming: directional signal transmission or reception. For a beamformed transmission, the amplitude and phase of each antenna in an array of antennas may be precoded, or controlled to create a desired (e.g., directional) pattern of constructive and destructive interference in the wavefront.

multiple-input multiple-output. MIME) is a multi-antenna technology that exploits multipath signal propagation so that the information-carrying capacity of a wireless link can be multiplied by using multiple antennas at the transmitter and receiver to send multiple simultaneous streams. At the multi-antenna transmitter, a suitable preceding algorithm (scaling the respective streams' amplitude and phase) is applied (in some examples, based on known channel state information). At the multi-antenna receiver, the different spatial signatures of the respective streams (and, in some examples, known channel state information) can enable the separation of these streams from one another.
1. In single-user MIMO, the transmitter sends one or more streams to the same receiver, taking advantage of capacity gains associated with using multiple Tx, Rx antennas in rich scattering environments where channel variations can be tracked.
2. The receiver may track these channel variations and provide corresponding feedback to the transmitter. This feedback may include channel quality information (CQI), the number of preferred data streams (e.g., rate control, a rank indicator (RI)), and a preceding matrix index (PMI).

Massive MIMO: a MIMO system with a very large, number of antennas (e.g., greater than an 8×8 array).

MU-MIMO: a multi-antenna technology where base station, in communication with a large number of UEs, can exploit multipath signal propagation to increase overall network capacity by increasing throughput and spectral efficiency, and reducing the required transmission energy.
1. The transmitter may attempt to increase the capacity by transmitting to multiple users using its multiple transmit antennas at the same time, and also using the same allocated time-frequency resources. The receiver may transmit feedback including a quantized version of the channel so that the transmitter can schedule the receivers with good channel separation. The transmitted data is precoded to maximize throughput for users and minimize inter-user interference.

AS: access stratum. A functional grouping consisting of the parts in the radio access network and in the UE, and the protocols between these parts being specific to the access technique (i.e., the way the specific physical media between the UE and the radio access network is used to carry information).

NAS: non-access stratum. Protocols between UE and the core network that are not terminated in the radio access network.

RAB: radio access bearer. The service that the access stratum provides to the non-access stratum for transfer of user information between a UE and the core network.

Network slicing: a wireless communication network may be separated into a plurality of virtual service networks (VSNs), or network slices, which are separately configured to better suit the needs of different types of services. Some wireless communication networks nay be separated, e.g., according to e IBB, IoT, and URLLC services.

eMBB: enhanced mobile broadband. Generally, eMBB refers to the continued progression of improvements to existing broadband wireless communication technologies such as LIE. eMBB provides for (generally continuous) increases in data. rates and increased network capacity.

IoT: the Internet of things. In general, this refers to the convergence of numerous technologies with diverse use cases into a single, common infrastructure. Most discussions of the IoT focus on machine-type communication (MIC) devices.

URLLC: ultra-reliable and low-latency communication. Sometimes equivalently called mission-critical communication. Reliability refers to the probability of success of transmitting a given number of bytes within 1 ms under a given channel quality. Ultra-reliable refers to a high target reliability, e.g., a packet success rate greater than 99.999%. Latency refers to the time it takes to successfully deliver an application layer packet or message. Low-latency refers to a low target latency, e.g., 1 ms or even 0.5 ms (for comparison, a target for eMBB may be 4 ms).

MTC: machine-type communication. A form of data communication that involves one or more entities that do not necessarily need human interaction. Optimization of MTC services differs from that for human-to-human communications because MTC services generally involve different market scenarios, data, communications, lower costs and effort, a potentially very large number of communicating terminals, and, to a large extent, little traffic per terminal. (See 3GPP TS 22.368.)

Duplex: a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and interference cancellation techniques. Full duplex emulation is frequently implemented for wireless links by utilizing frequency division duplex (FDD) or time division duplex (TDD). In FDD, the transmitter and receiver at each endpoint operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction.

OFDM: orthogonal frequency division multiplexing. An air interface may be defined according to a two-dimensional grid of resource elements, defined by separation of resources in frequency by defining a set of closely spaced frequency tones or sub-carriers, and separation in time by defining a sequence of symbols having a given duration. By setting the spacing between the tones based on the symbol rate, inter-symbol interference can be eliminated. OFDM channels provide for high data rates by allocating a data stream in a parallel manner across multiple subcarriers.

CP: cyclic prefix. A multipath environment degrades the orthogonality between subcarriers because symbols received from reflected or delayed paths may overlap into the following symbol. A CP addresses this problem by copying the tail of each symbol and pasting it onto the front of the OFDM symbol. In this way, any multipath components from a previous symbol fall within the effective guard time at the start of each symbol and can be discarded.

Sealable numerology: in OFDM, to maintain orthogonality of the subcarriers or tones, the subcarrier spacing is equal to the inverse of the symbol period. A scalable numerology refers to the capability of the network to select different subcarrier spacings, and accordingly, with each spacing, to select the corresponding symbol period. The symbol period should be short enough that the channel does not significantly vary over each period, in order to preserve orthogonality and limit inter-subcarrier interference.

RSMA: resource spread multiple access. A non-orthogonal multiple access scheme generally characterized by small, grantless data bursts in the uplink where signaling over head is a key issue, e.g., for IoT.

LBT: listen before talk. A non-scheduled, contention-based multiple access technology where a device monitors or senses a carrier to determine if it is available before transmitting over the carrier. Some LBT technologies utilize signaling such as a request to send (RTS) and a clear to send (CTS) to reserve the channel for a given duration of time.

D2D: device-to-device. Also point-to-point (P2P). D2D enables discovery of, and communication with nearby devices using a direct link between the devices (i.e., without passing through a base station, relay, or other node). D2D can enable mesh networks, and device-to-network relay functionality. Some examples of 1.72.1) technology include Bluetooth pairing, Wi-Fi Direct, Miracast, and LTE-D.

IAB: integrated access and backhaul. Some base stations may be configured as IAB nodes, where the wireless spectrum may be used both for access links (i.e., wireless links with UEs) and for backhaul links. This scheme is sometimes referred to as wireless self-backhauling. By using wireless self-backhauling, rather than requiring each new base station deployment to be outfitted with its own hard-wired backhaul connection, the wireless spectrum utilized for communication between the base station and UE may be leveraged for backhaul communication, enabling fast and easy deployment of highly dense small cell networks.

QoS: quality of service. The collective effect of service performances which determine the degree of satisfaction of a user of a service, QoS is characterized by the combined aspects of performance factors applicable to all services, such as: service operability performance; service accessibility performance; service retainability performance; service integrity performance; and other factors specific to each service.

Blockechain: a distributed database and transaction processing technology having certain features that provide secure and reliable records of transactions in a way this is very resistant to fraud or other attacks. When a transaction takes place, many copies of a transaction record are sent to other participants in a network, each of which simultaneously confirms the transaction via a mathematical calculation, Blocks are accepted via a scoring algorithm based on these confirmations. A block is a group or batch of transaction records, including a timestamp and a hash of a previous block, linking the blocks to one another. This string of blocks forms a blockchain. In a wireless communication network, especially one with large numbers of IoT devices, a blockchain can improve security and trust to the ability for any type of transaction or instructions between devices.

The various concepts presented throughout this disclosure may be implemented across a broad variety of telecommunication systems, network architectures, and communication standards. Referring now to FIG, 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services. Within the present disclosure, the terms mobile apparatus and mobile device may be used interchangeably.

Within the present document, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RE chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smarthook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g,, a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs),

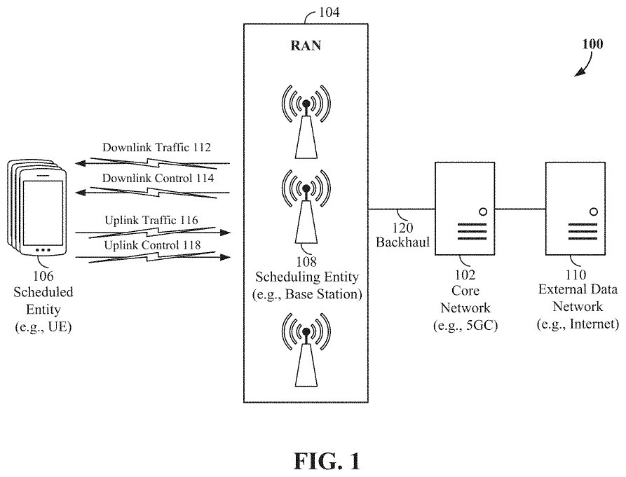

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information in downlink control 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

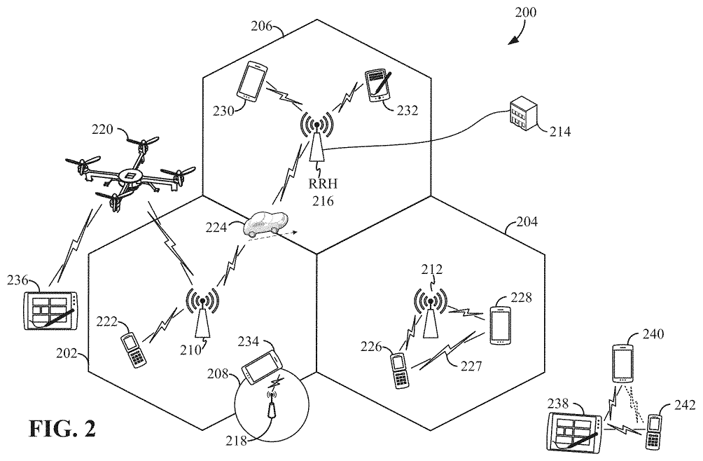

Referring now to FIG. 2, by way of example and without limitation, a schematic illustration of a random access network (referred to herein as RAN 200) is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204.A third base station 214 is shown controlling a remote radio head (RRH) 216 in cell 206, That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. The wireless access points may be referred to as network access nodes herein. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In sonic examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE, For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network, In a mesh network example, UEs 240 and 242 may optionally communicate directly with one another in addition to communicating with UE 238 (e.g., when serving as the scheduling entity). Thus, in a wireless communication system with scheduled access to time-frequency resources and having a cellular configuration, a P2P configuration, or a mesh configuration, a scheduling entity and one or more scheduled entities may communicate utilizing the scheduled resources.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

In various aspects of the disclosure, a RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells, During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the LIE 224 may receive a handover command, and the UE may undergo a handover to the cell 206.

in a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSS) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body, Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

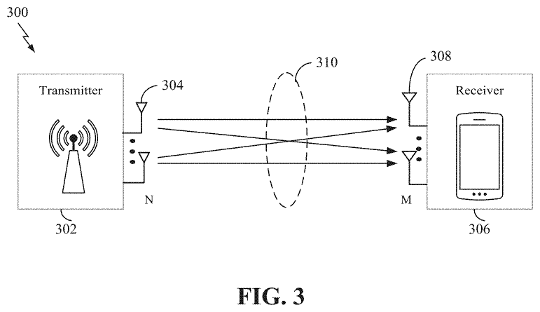

In some aspects of the disclosure, the scheduling entity and/or scheduled entity may be configured for beamforming and/or multiple-input multiple-output (MIMO) technology. FIG. 3 is a block diagram illustrating an example of a wireless communication system supporting MIMO communication (a MIMO wireless communication system 300). In a MIMO system, a transmitter 302 includes multiple transmit antennas 304 (e.g., N transmit antennas) and a receiver 306 includes multiple receive antennas 308 M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device,

The use of such multiple antenna. technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO) This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE, On the uplink, each UE transmits a spatially precoded data stream, which enables the base station to identify the source of each spatially precoded data stream.

The number of data streams or layers corresponds to the rank of the transmission. In general, the rank of the MIMO wireless communication system 300 is limited by the number of transmit or receive antennas 304 or 308, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI. along with resource information (e.g., the available resources and amount of data. to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal). Based on the assigned rank, the base station may then transmit channel state information reference signals (CSI-RS) with separate cell-specific reference signal (C-RS) sequences for each layer to provide for multi-layer channel estimation. From the CSI-RS, the UE may measure the channel quality across layers and resource blocks and feed back the channel quality information (CQI) rank indicator (RI) values to the base station for use in updating the rank and assigning resource elements (REs) for future downlink transmissions.

In the simplest case, as shown in FIG. 3, a rank-2 spatial multiplexing transmission on a 2×2 MIMO antenna configuration will transmit one data stream from each transmit antenna 304. Each data stream reaches each receive antenna 308 along a different signal path 310 (also referred to as a radio channel). The receiver 306 may then reconstruct the data streams using the received signals from each receive antenna 308.

In order for transmissions over the RAN 200 to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences, For these channels, puncturing, shortening, and repetition are used for rate matching.

However, those of ordinary skill in the art will understand that aspects of the present disclosure may be implemented utilizing any suitable channel code, Various implementations of scheduling entities 108 and scheduled entities 106 may include suitable hardware and capabilities (e.g., an encoder, a decoder, and/or a CODEC) to utilize one or more of these channel codes far wireless communication.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-0MM (DFT-s-OMM) with a. CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

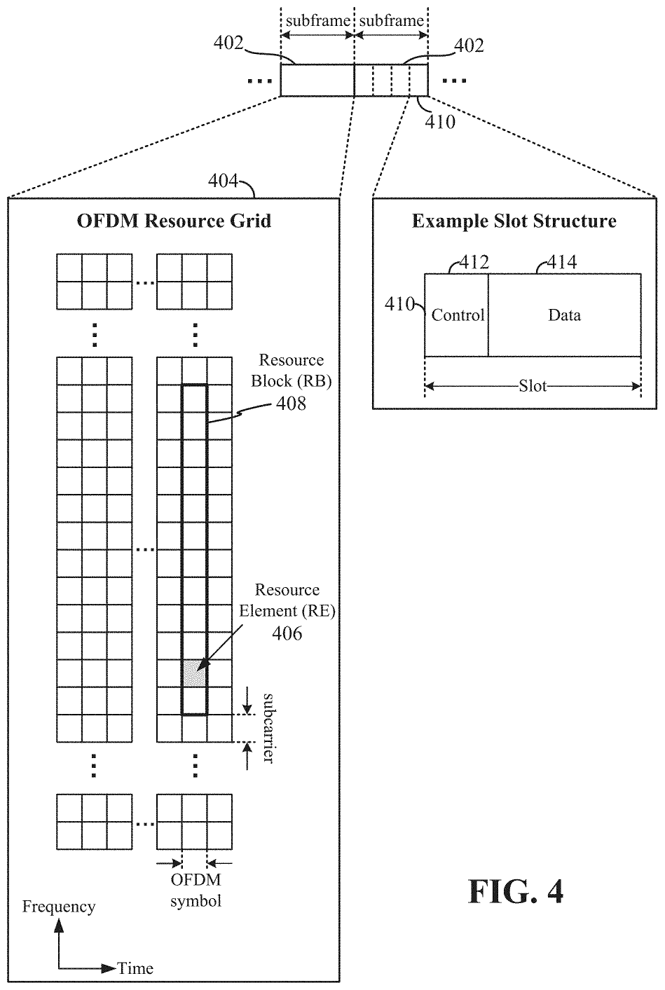

Various aspects of the present disclosure will be described with reference to an OFDM waveform, schematically illustrated in FIG. 4. It should be understood by those of ordinary skill in the art that the various aspects of the present disclosure may be applied to a DFT-s-OFDMA waveform in substantially the same way as described herein below. That is, while some examples of the present disclosure may focus on an OFDM link for clarity, it should be understood that the same principles may be applied well to DFT-s-OFDMA waveforms.

Within the present disclosure, a frame refers to a duration of 10 ms for wireless transmissions, with each frame consisting of 10 subframes of 1 ms each. On a given carrier, there may be one set of frames in the UL, and another set of frames in the DL. Referring now to FIG. 4, an expanded view of an exemplary DL subframe 402 is illustrated, showing an OFDM resource grid 404. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers or tones.

The resource grid 404 may be used to schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A UE generally utilizes only a subset of the resource grid 404. An RB may be the smallest unit of resources that can be allocated to a UE. Thus, the more RBs scheduled for a UE, and the higher the modulation scheme chosen for the air interface, the higher the data rate for the UE.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each subframe 402 (e.g., a 1 ms subframe) may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The simple structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In a downlink (DL) transmission, the transmitting device (e.g., the scheduling entity 108) may allocate one or more REs 406 (e.g., within a control region 412) to carry downlink control information (DCI) including one or more DL control channels that generally carry information originating from higher layers, such as a physical broadcast channel (PBCH), a physical downlink control channel (PDCCH), etc., to one or more scheduled entities 106. In addition, DL REs may be allocated to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The synchronization signals PSS and SSS (collectively referred to as SS), and in some examples, the PBCH, may be transmitted in an SS block that includes 4 consecutive OFDM symbols, numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration, Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL. transmissions.

In an uplink (UL) transmission, a transmitting device (e.g., a scheduled entity 106) may utilize one or more REs 406 to carry uplink control information (UCI). The UCI can originate from higher layers via one or more UL channels, such as a physical uplink control channel (PUCCH), a physical random access channel (PRACH), etc., to the scheduling entity 108. Further, UL REs may carry UL physical signals that generally do not carry information originating from higher layers, such as demodulation reference signals (DM-RS), phase-tracking reference signals (PT-RS), sounding reference signals (SRS), etc. In some examples, the UCI may include a scheduling request (SR), i.e., a request for the scheduling entity 108 to schedule uplink transmissions. Here, in response to the SR transmitted on the uplink control 118 channel, the scheduling entity 108 may transmit downlink control information (DCI) on the downlink control 114 channel that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a. NACK, the transmitting device may send a HARQ retransmission, which may implement chase combining, incremental redundancy, etc.

In addition to control information, one or more REs 406 (e.g., within the data region 414) may be allocated for user data or traffic data. Such traffic may be carried on one or more traffic channels, such as, for a DL transmission, a physical downlink shared channel (PDSCH); or for an UL transmission, a physical uplink shared channel (PUSCH).

In order for a UE to gain initial access to a cell, the RAN may provide system information (SI) characterizing the cell. This system information may be provided utilizing minimum system information (MSI), and other system information (051). The MSI may be periodically broadcast over the cell to provide the most basic information required for initial cell access, and for acquiring any OSI that may be broadcast periodically or sent on-demand. In some examples, the MSI may be provided over two different downlink channels. For example, the PBCH may carry a master information block (MIB), and the PDSCH may carry a system information block type 1 (SIB1). In the art, SIB1 may be referred to as the remaining minimum system information (RMSI).

OSI may include any SI that is not broadcast in the MSI. In some examples, the PDSCH may carry a plurality of SIBS, not limited to SIB1, discussed above. Here, the OSI may be provided in these SIBs, e.g., SIB1 and above.

The channels or carriers described above and illustrated FIGS. 1 and 4 are not necessarily all the channels or carriers that may be utilized between a scheduling entity 108 and scheduled entities 106, and those of ordinary skill in the art will recognize that other channels or carriers may be utilized in addition to those. illustrated, such as other traffic, control, and feedback channels.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

OFDM, to maintain orthogonality of the subcarriers or tones, the subcarrier spacing may be equal to the inverse of the symbol period. A numerology of an OFDM waveform refers to its particular subcarrier spacing and cyclic prefix (CP) overhead. A scalable numerology refers to the capability of the network to select different subcarrier spacings, and accordingly, with each spacing, to select the corresponding symbol duration, including the CP length. With a scalable numerology, a nominal subcarrier spacing (SCS) may be scaled upward or downward by integer multiples. In this manner, regardless of CP overhead and the selected SCS, symbol boundaries may be aligned at certain common multiples of symbols (e.g., aligned at the boundaries of each I ms subframe). The range of SCS may include any suitable SCS. For example, a scalable numerology may support a SCS ranging from 15 kHz to 480 kHz.

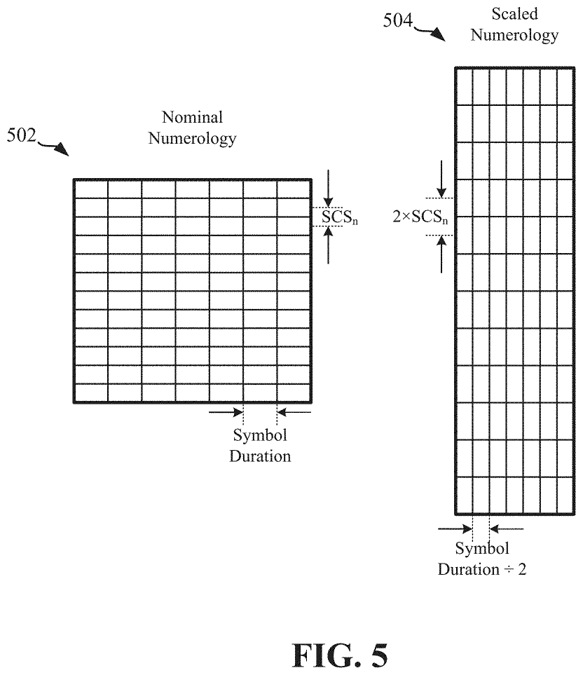

To illustrate this concept of a scalable numerology, FIG. 5 shows a first RB 502 having a nominal numerology, and a second RB 504 having a scaled numerology. As one example, the first RB 502 may have a ‘nominal’ subcarrier spacing (SCSₙ) of 30 kHz, and a ‘nominal’ symbol durations of 333 μs. Here, in the second RB 504, the scaled numerology includes a scaled SCS of double the nominal SCS, or 2×SCSₙ=60 kHz. Because this provides twice the bandwidth per symbol, it results in a shortened symbol duration to carry the same information. Thus, in the second RB 504, the scaled numerology includes a scaled symbol duration of half the nominal symbol duration, or (symbol durationₙ)÷2=167 μs.

### Scheduling Entity

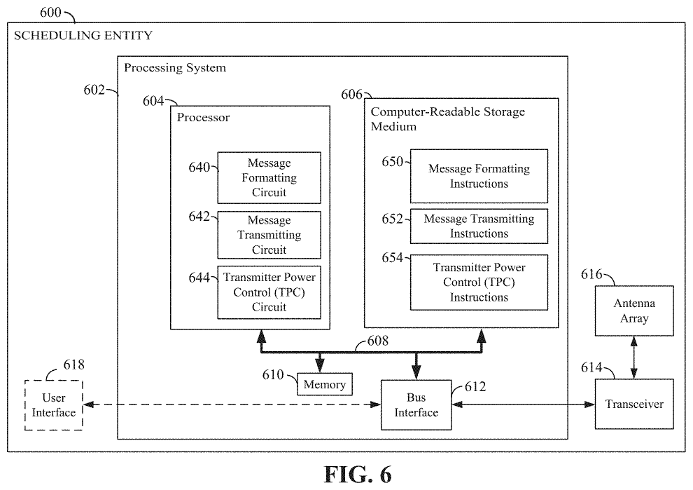

FIG. 6 is a block diagram conceptually illustrating an example of a hardware implementation for a scheduling entity 600 employing a processing system 602 according to some aspects of the disclosure. For example, the scheduling entity 600 may be a. network access node, a base station, a gNB, an eNB, as illustrated in any one or more of FIGS. 1, 2, and/or 3. In another example, the scheduling entity 600 may be a user equipment (UE) as illustrated in any one or more of FIGS. 1, 2, and/or 3.

The scheduling entity 600 may be implemented with a processing system 602 that includes one or more processors 604. Examples of processors 604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 600 may be configured to perform any one or more of the functions described herein. That is, the processor 604, as utilized in a scheduling entity 600, may be used to implement any one or more of the processes and procedures described below and illustrated in FIGS. 11-14.

In this example, the processing system 602 may be implemented with a bus architecture, represented generally by the bus 608. The bus 608 may include any number of interconnecting buses and bridges depending on the specific application of the processing system 602 and the overall design constraints. The bus 608 communicatively couples together various circuits including one or more processors (represented generally by the processor 604), a memory 610, and computer-readable media (represented generally by the computer-readable storage medium 606). The bus 608 may also link various other circuits such as timing sources, peripherals, voltage regulators, and power management circuits, which are well known in the art, and therefore, will not be described any further. A bus interface 612 provides an interface between the bus 608 and a transceiver 614. The transceiver 614 may incorporate a transmitter and a receiver and may couple to an antenna array 616. The transceiver 614 (via the antenna array 616) provides a communication interface or means for communicating with various other apparatus over a transmission medium, Depending upon the nature of the apparatus, a user interface 618 (e.g., keypad, display, speaker, microphone, joystick) may also be provided. Of course, such a user interface 618 is optional, and may be omitted in some examples, such as a base station.

In some aspects of the disclosure, the processor 604 may include message formatting circuitry 640 configured for various functions, including, for example, formatting a message to convey a transmitter power control (TPC) command to be implemented at a plurality of cells. The processor 604 may further include, for example, message transmitting circuitry 642 configured for various functions, including, for example, transmitting the message to a scheduled entity. The processor 604 may further include, for example, TPC circuitry 644 configured for various functions, including, for example, determining a power level or delta power level to include in a TPC command and/or determining which cell or groups of cells should be associated with a given power lever or delta power level. The message formatting circuitry 640, the message transmitting circuitry 642, and the TPC circuitry 644 may be configured to implement one or more of the functions described below in relation to FIGS. 11 and/or 12 including, e.g., blocks 1102, 1104, and 1106 of FIG. 11.

The processor 604 is responsible for managing the bus 608 and general processing, including the execution of software stored on the computer-readable storage medium 606. The software, when executed by the processor 604, causes the processing system 602. to perform the various functions described below for any particular apparatus. The computer-readable storage medium 606 and the memory 610 may also be used for storing data that is manipulated by the processor 604 when executing software.

One or more processors 604 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 606.

The computer-readable storage medium 606 may be a non-transitory computer-readable storage medium storing computer-executable code. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium 606 may reside in the processing system 602, external to the processing system 602, or distributed across multiple entities including the processing system 602. The computer-readable storage medium 606 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

In one or more examples, the computer-readable storage medium 606 may include message formatting instructions 650 (e.g., software) configured for various functions, including, for example, formatting a. message to convey a TPC command to be implemented at a plurality of cells. The computer-readable storage medium 606 may further include, for example, message transmitting instructions 652 (e.g., software) configured for various functions, including, for example, transmitting the message to a scheduled entity. The computer-readable storage medium 606 may further include, for example, TPC instructions 654 (e.g., software) configured for various functions, including, for example, determining a power level or delta power level to include in a TPC command and/or determining which cell or groups of cells should be associated with a given power lever or delta power level. The same and/or additional instructions (e.g., software) may be configured to implement one or more of the functions described below in relation to FIGS. 11 and/or 12 including, e.g., blocks 1102, 1104, and 1106 of FIG. 11.

Taken together the message formatting circuitry 640, message transmitting circuitry 642, and the transmit power control (TPC) circuitry 644 may allow wireless communication, implementing dynamic spectrum sharing (DSS), operational at the scheduling entity 600,

### Scheduled Entity

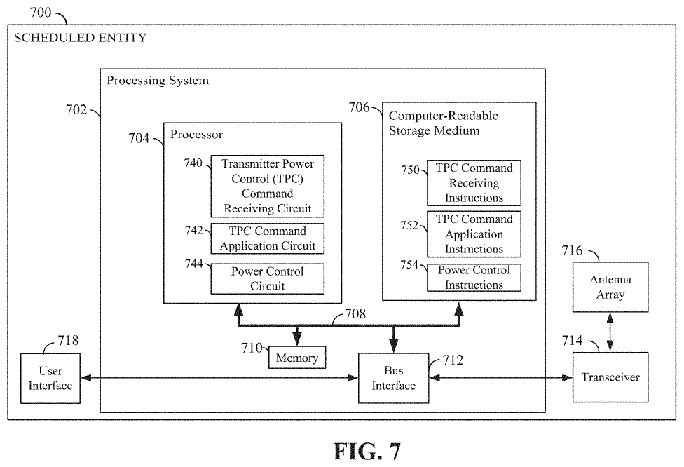

FIG. 7 is a block diagram conceptually illustrating an example of a hardware implementation for a scheduled entity 700 employing a processing system 702 according to some aspects of the disclosure. In accordance with various aspects of the disclosure, an element, or any portion of an element, or any combination of elements may be implemented with a processing system 702 that includes one or more processors 704. For example, the scheduled entity 700 may be a user equipment (UE), a user device, a mobile device, as illustrated in any one or more of FIGS. 1, 2, and/or 3.

The processing system 702 may be substantially the same as the processing system 602 illustrated in FIG. 6, including a bus interface 712, a bus 708, memory 710, a processor 704, and a computer-readable storage medium 706. Furthermore, the scheduled entity 700 may include a user interface 718 and a transceiver 714 substantially similar to those described above in FIG. 6. The transceiver 714 may incorporate a transmitter and a receiver and may couple to an antenna array 716. The transceiver 714 (via the antenna array 716) provides a communication interface or means for communicating with various other apparatus over a transmission medium. The processor 704, as utilized in a scheduled entity 700, may be used to implement any one or more of the processes described below and illustrated in FIGS. 11-14.

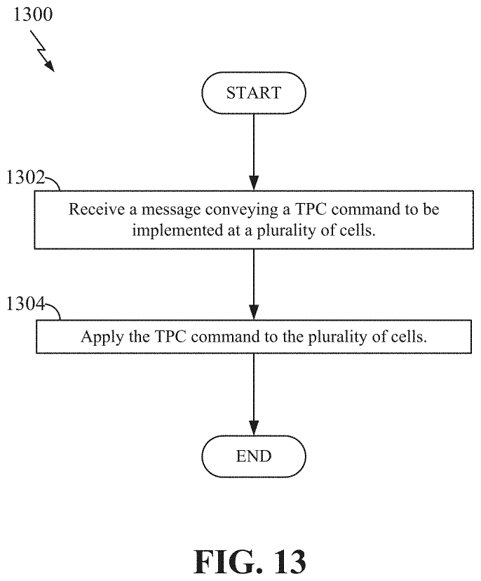

In some aspects of the disclosure, the processor 704 may include, for example, transmitter power control (TPC) command receiving circuitry 740 configured for various functions, including, for example, receiving a message conveying a TPC command to be implemented at a plurality of cells. According to some aspects, the message may be a DC1 message that schedules a plurality of uplink transmissions in the plurality of cells. The uplink transmissions may include SRS, PUCCH, PUSCH, PRACH, or any combination thereof. The processor 704 may further include, for example, TPC command application circuitry 742 configured for various functions, including, for example, applying the TPC command to the plurality of cells. For example, DCI format 1_1 can be used to schedule multiple PDSCHs in the plurality of cells and the TPC command can indicate for the corresponding group of PITCH in the cells. Similarly, DCI format 0_1 is used for the transmission of TPC commands for a group of PUSCH, DCI format 2_2 is used for the transmission of TPC commands for a group of PUCCH and PUSCH, and DCI format 2_3 is used for the transmission of a group of TPC commands for SRS transmissions by one or more UEs. The processor 704 may further include, for example, power control circuitry 744 configured for various functions, including, for example, determining a power level or delta power level to include in a TPC command and/or determining which cell or groups of cells should be associated with a given power lever or delta power level. The TPC command receiving circuitry 740, the TPC command application circuitry 742, and the power control circuitry 744 may be configured to implement one or more of the functions described relation to FIGS. 13 and/or 14, including, e.g., blocks 1302 and 1304 of FIG. 13.

In one or more examples, the computer-readable storage medium 706 may include TPC command receiving instructions 750 (e.g., software) configured far various functions, including, for example, receiving a message conveying a TPC command to he implemented at a plurality of cells. The computer-readable storage medium 706 may further include, for example, TPC command application instructions 752 (e.g., software) configured for various functions, including, for example, applying the TPC command to the plurality of cells The computer-readable storage medium 706 may further include, for example, power control instructions 754 (e.g., software) configured for various functions, including, for example, determining a power level or delta power level to include in a TPC command and/or determining which cell or groups of cells should be associated with a given power lever or delta power level. The same and/or additional instructions (e.g., software) may be configured to implement one or more of the functions described in relation to FIGS. 13 and/or 14, including e.g., blocks 1302 and 1304 of FIG. 13.

Taken together the transmitter power control (TPC) command receiving circuitry 740, the TPC command application circuitry 742, and the power control circuitry 744, may allow wireless communication, implementing dynamic spectrum sharing(DSS), operational at the scheduled entity 700.

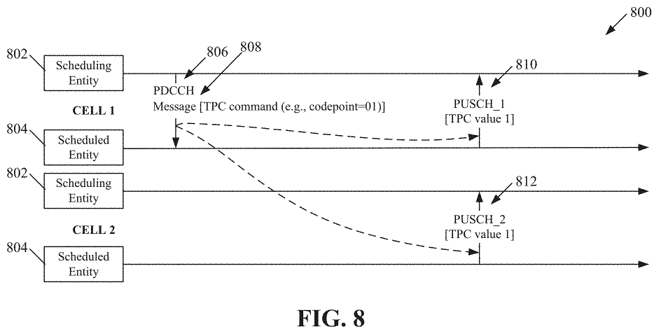

FIG. 8 is a call flow diagram 800 between a scheduling entity 802 (e.g., a network access node, a gNB, and eNB) and a scheduled entity 804 (e.g., a user equipment, user device, mobile device) according to some aspects of the disclosure, In the illustrative and non-limiting example of FIG. 8, a physical downlink control channel (PDCCH 806) schedules multiple physical uplink shared channels (PUSCH_1 810, PUSCH_2 812) on multiple cells (Cell 1, Cell 2) (e.g., carriers, component carriers) using a single message 808 (e.g., at least one of a radio resource control (RRC) message, a medium access control-control element (MAC-CE), or a downlink control information (DCI)). According to some aspects, the single message 808 of PDCCH 806 schedules PUSCH_1 810 and PUSCH_2 812 (as represented by the dashed line arrows emanating from PDCCH 806 and terminating at PUSCH_1 810 and PUSCH_2 812). According to some aspects, the single message 808 may schedule at least two channels (e.g., two or more PUSCH),

The single message 808 may include a TPC command. For example, the TPC command may comprise a codepoint, which may be a binary number identifying a predetermined absolute power level (e.g., expressed in mW or dBm) or a predetermined delta power level (e.g., expressed in dB). In the example of FIG. 8 the TPC command indicates a codepoint of binary “01”, which corresponds to a predetermined TPC value of 1 (where 1 may represent at least one of an absolute power level or a delta power level). According to this non-limiting example, a common transmit power (represented as TPC value 1) is commanded to be set at both PUSCH_1 810 and PUSCH_2 812. The exemplary TPC codepoint is depicted as binary “01”; however, the TPC codepoint may be any representation (e.g., binary, hexadecimal) of a numeric value representing an absolute power level or a delta power level (e.g., an increase or decrease of a presently used power level by a specified differential amount).

In FIG. 8, transmission on both Cell 1 and Cell 2 is commanded to TPC value 1. Cell 1 may be, for example, a primary component carrier (e.g., a PCell) and Cell 2 may be, for example, a secondary component carrier (e.g,, a SCell). However, Cell 1 and Cell 2 could both be PCells or could both be SCells according to aspects described herein. In the example of FIG. 8, both PUSCH_1 810 and PUSCH_2 812 are successfully decoded and no retransmission of either is required.

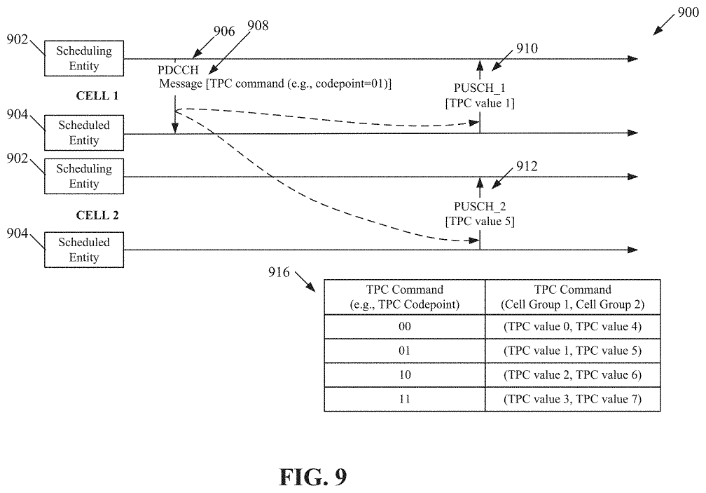

FIG, 9 is a second call flow diagram 900 between a scheduling entity 902 (e.g., a network access node, a gNB, and eNB) and a scheduled entity 904 (e.g., a user equipment, user device, mobile device) according to some aspects of the disclosure. In the illustrative and non-limiting example of FIG. 9, a physical downlink control channel (PDCCH 906), schedules multiple physical uplink shared channels (PUSCH_1 910, PUSCH_2 912) on multiple cells (Cell 1, Cell 2) (e.g., carriers, component carriers) using a single message 908 (e.g., at least one of a radio resource control (RRC) message, a. medium access control-control element (MAC-CE), or a downlink control information (DCI)). According to some aspects, the single message 908 of PDCCH 906 schedules PUSCH_1 910 and PUSCH_2 912 (as represented by the dashed line arrows emanating from PDCCH 906 and terminating at PUSCH_1 910 and PUSCH_2 912). According to some aspects, the single message 908 may schedule at least two channels (e.g., two or more PUSCH).

The single message 908 may include a TPC command. The TPC command may include a codepoint, which may represent a plurality of TPC values for a respective plurality of cell groups (e.g,, cell group 1, cell group 2, etc.). A table 916 in FIG. 9 provides a cross-reference between the TPC codepoint and the TPC values associated with cell group 1 and cell group 2. According to some aspects, more than two cell groups may be represented by a TPC codepoint. For example, a TPC codepoint having two binary digits could represent four cell groups. In the example of FIG. 9 the TPC command indicates a codepoint of binary “01”, which corresponds to a predetermined set of TPC values for cell group 1 and cell group 2. As illustrated the codepoint of binary “01” corresponds to a TPC value of 1 for cell group 1, represented by Cell 1 in FIG. 9, and a TPC value of 5 for cell group 2, represented by Cell 2. RRC and MAC-CE signaling can be used to configure the table 916, which associates each TPC codepoint in the DCI with exact TPC values in different cells. For example, RRC signaling can configure a list of entries, where each entry contains TPC values for multiple cell groups, and MAC-CE signaling can select a subset of entries from the list. The DCI codepoints for TPC command can be mapped to the entries in the subset selected by the MAC-CE signaling. It will be understood that more than one cell may be included in any cell group. A cell in a cell group may be, for example, a primary component carrier (e.g., a PCell) or a secondary component carrier (e.g., a SCell). All combinations of PCells and SCells are contemplated according to aspects described herein. In the example of FIG. 9, both PUSCH_1 910 and PUSCH_2 912 are successfully decoded and no retransmission of either is required.

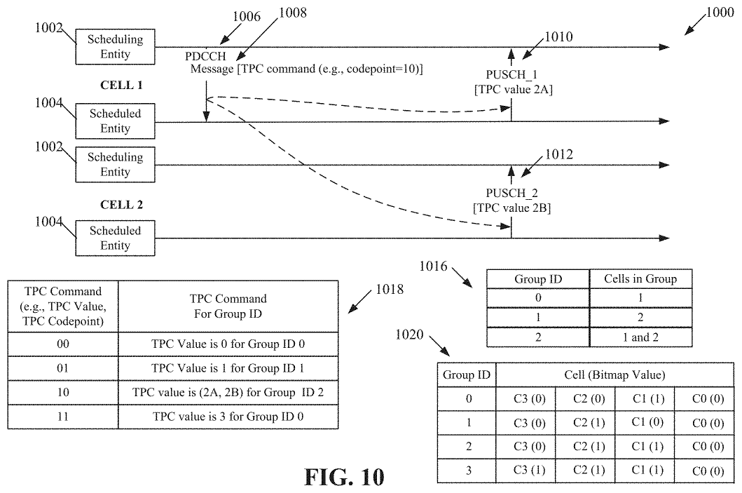

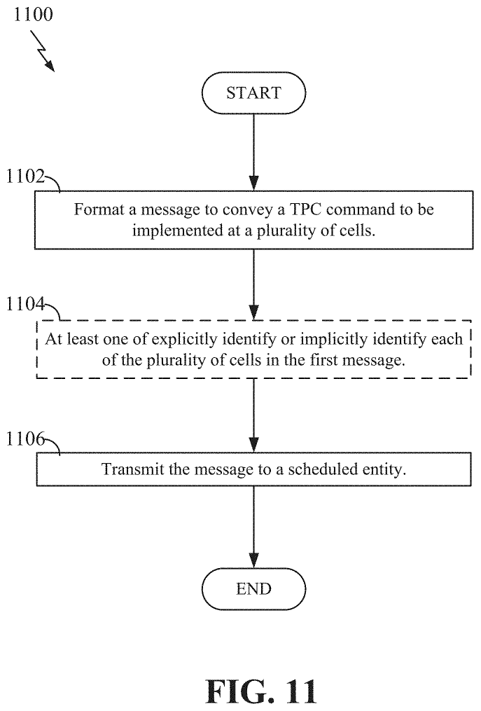

FIG. 10 is a third call flow diagram 1000 between a scheduling entity 1002 (e,g., a network access node, a gNB, and eNB) and a scheduled entity 1004 (e.g., a user equipment, user device, mobile device) according to some aspects of the disclosure, In the illustrative and non-limiting example of FIG. 10, a physical downlink control channel (PDCCH 1006), schedules multiple physical uplink shared channels (PUSCH_1 1010, PUSCH_2 1012) on multiple cells (Cell 1, Cell 2) (e.g., carriers, component carriers) using a single message 1008 (e.g,, at least one of a radio resource control (RRC) message, a medium access control-control element (MAC-CE), or a downlink control information (DCI)). According to some aspects, the single message 1008 of PDCCH 1006 schedules PUSCH_1 1010 and PUSCH_2 1012 (as represented by the dashed line arrows emanating from PDCCH 1006 and terminating at PUSCH_1 1010 and PUSCH_2 1012). According to some aspects, the single message 1008 may schedule at least two channels (e.g., two or more PUSCH).

According to one aspect of the exemplary illustration of FIG. 10, the transmit power for each PUSCH (PUSCH_1 1010, PUSCH_2 1012) is established with a single value represented as a TPC codepoint identified in the single message 1008 transported, for example, via the PDCCH 1006.

According to one example, and as illustrated in a table 1018 at the left lower edge of FIG. 10, the TPC codepoint 10 corresponds to TPC value 2A for Cell 1 and TPC value 2B for Cell 2, where Cell 1 and Cell 2 are members of group ID 2. RRC and MAC-CE signaling can be used to configure the table 1018. For example, RRC signaling can configure a list of entries, where each entry has a group IDs and the corresponding TPC values associated with the group ID. MAC-CE signaling can select a subset of entries from the list. The DCI codepoints for TPC command can be mapped in order to the entries in the subset selected by the MAC-CE signaling.

According to one example, and as illustrated in a table 1016 in the right middle of the figure, the group ID may represent one or more cells as members of the group identified by the group ID. According to one example, and as illustrated in the table 1016, group ID 2 corresponds to Cell 1 and Cell 2. Individual power levels (TPC value 2A for Cell 1 and TPC value 2B for Cell 2) may be provided by using the TPC command to identify group IDs and TPC treatment of cells within the group IDs. RRC and MAC-CE signaling can be used to configure the table 1016, which associates each group ID with one or more cells in a group of cells. For example, RRC signaling can configure a list of group IDs and the corresponding cells associated each group ID. MAC-CE signaling can select a subset from the list, In another way, the MAC-CE signaling can also update a group ID to be associated with a group of different cells (e.g., add cells, subtract cells, or otherwise change the membership of the cells associated with a given group ID).

According to another example, and as illustrated in a bitmap table 1020 in the bottom right of FIG. 10, the cells of a given group ID may be represented by the bitmap table 1020. For example, according to the bitmap table 1020, group ID 0 includes cell C1 (but not cells C0, C2, and C3). Group ID 1 includes cell C2 (but not cells C0, C1, and C3), Group ID 2 includes cells C1 and C2 (hut not C0 and C3), Group ID 3 includes cells C1, C2, and C3 (but not C0). In the example of FIG. 10, both PUSCH_1 1010 and PUSCH_2 1012 are successfully decoded and no retransmission of either is required. RRC and MAC-CE signaling can be used to configure the bitmap table 1020, which associates each group ID with a group of cells, For example, RRC signaling can configure a list of group IDs and the bitmap with the corresponding cells associated with the group ID. MAC-CE signaling can select a subset from the list. In another way, the MAC-CE signaling can also update a group ID with a new bitmap that is associated with a group of different cells, Similarly, the MAC-CE can add or remove group IDs and their associated bitmap table entries to or from the bitmap table 1020, respectively.

FIG. 11 is a flow chart illustrating an exemplary process 1100 for wireless communication, operational at a scheduling entity, according to sonic aspects of the disclosure. The process 1100 may be used to implement dynamic spectrum sharing. FIG, 12 is a second flow chart illustrating an exemplary process 1200 for wireless communication, operational at a scheduling entity according to some aspects of the disclosure. The process 1200 may be used to implement dynamic spectrum sharing. As described below, some or all illustrated features in each of the figures may be omitted in a particular implementation within the scope of the present disclosure, and some illustrated features may not be required for implementation of all embodiments. In some examples, the processes 1100, 1200 may be carried out by the scheduling entity 600 illustrated in FIG. 6. In some examples, the processes 1100, 1200 may be carried out by any suitable apparatus or means for carrying out the functions or algorithm described below.

Turning to FIG. 11, at block 1102, the scheduling entity may format a message to convey a TPC command to be implemented at a plurality of cells. At block 1104, the scheduling entity may optionally explicitly identify or implicitly identify each of the plurality of cells in the message. At block 1106, the scheduling entity may transmit the message to a scheduled entity.

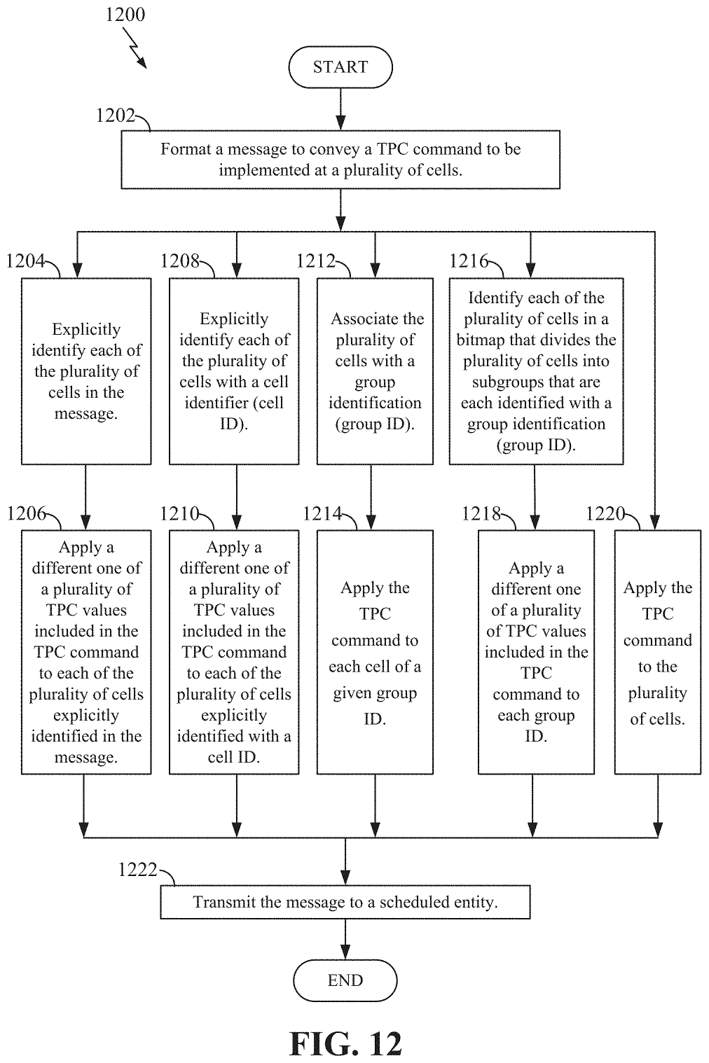

Turning to FIG. 12, at block 1202, the scheduling entity nay format a message to convey a TPC command to be implemented at a plurality of cells, According to some aspects, the message associates the plurality of cells with a group identification (group ID). According to some aspects, the TPC command includes a plurality of TPC values. At block 1204, the scheduling entity may explicitly identify each of the plurality of cells in the message. At block 1206, the scheduling entity may apply a different one of a plurality of TPC values included with the TPC command to each of the plurality of cells explicitly identified in the message. Alternatively, at block 1208, the scheduling entity, may explicitly identify each of the plurality of cells with a cell identifier (cell ID). At block 1210, the scheduling entity may apply a different one of a plurality of TPC values included with the TPC command to each of the plurality of cells explicitly identified with a cell ID. Alternatively at block 1212, the scheduling entity may associate the plurality of cells with a group identification (group ID). At block 1214, the scheduling entity may apply the TPC command to each cell of a given group ID. Alternatively, at block 1216, the scheduling entity may identify each of the plurality of cells in a bitmap that divides the plurality of cells into subgroups that are each identified with a group identification (group ID). At block 1218, the scheduling entity may apply a different one of a plurality of TPC values included with TPC command to each group ID. Alternatively, at block 1220, the scheduling entity may apply the TPC command to the plurality of cells. At block 1222, the scheduling entity may transmit the message to a scheduled entity,

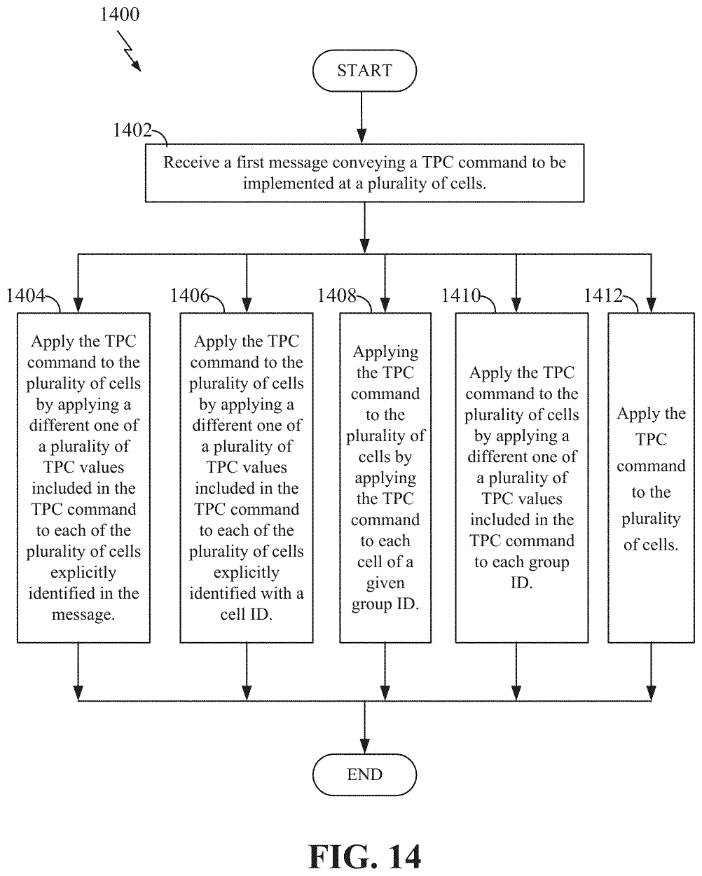

FIG. 13 is a flowchart illustrating an exemplary process 1300 for wireless communication, operational at a scheduled entity according to some aspects of the disclosure. The process 1300 may be used to implement dynamic spectrum sharing. FIG. 14 is a second flow chart illustrating an exemplary process 1400 for wireless communication, operational at a scheduled entity according to some aspects of the disclosure. The process 1400 may be used to implement dynamic spectrum sharing. As described below, some or all illustrated features in each of the figures may be omitted in a particular implementation within the scope of the present disclosure, and some illustrated features may not be required for implementation of all embodiments. In some examples, the processes 1300, 1400 may be carried out by the scheduled entity 700 illustrated FIG. 7. In some examples, the processes 1300, 1400 may be carried out by any suitable apparatus or means for carrying out the functions or algorithm described below.

Turning to FIG. 13, at block 1302, the scheduled entity may receive a message conveying a TPC command to be implemented at a plurality of cells. At block 1304, the scheduled entity may apply the TPC command to the plurality of cells.

Turning to FIG. 14, at block 1402, the scheduled entity may receive a message (e.g., a first message) conveying a TPC command to be implemented at a plurality of cells. According to some aspects, the TPC command includes a plurality of TPC values. At block 1404 the scheduled entity may apply the TPC command to the plurality of cells by applying a different one of a plurality of TPC values included with the TPC command to each of the plurality of cells explicitly identified in the message. Alternatively, at block 1406, the scheduled entity may apply the TPC command to the plurality of cells by applying a different one of the plurality of TPC values included with the TPC command to each of the plurality of cells explicitly identified with a cell ID. Alternatively, at block 1408, the scheduled entity may apply the TPC command to the plurality of cells by applying the TPC command to each cell of a given group ID. Alternatively, at block 1410, the scheduled entity may apply the TPC command to the plurality of cells by applying a different one of a plurality of TPC values included with the TPC command to each group ID. Alternatively, at block 1412, the scheduled entity may apply the TPC command. to the plurality of cells.

In one configuration, the apparatus 600 for wireless communication includes means for formatting a message to convey a TPC command to be implemented at a plurality of cells; and means for transmitting the message to a scheduled entity. In one aspect, the aforementioned means may be the processor 604 shown in FIG. 6 configured to perform the functions recited by the aforementioned means. In another aspect, the aforementioned means may be a circuit or any apparatus configured to perform the functions recited by the aforementioned means.

Of course, in the above examples, the circuitry included in the processor 604 is merely provided as an example, and other means for carrying out the described functions may be included within various aspects of the present disclosure, including but not limited to the instructions stored in the computer-readable storage medium 606, or any other suitable apparatus or means described in any one of the FIGS. 1, 2, and/or 3, and utilizing, far example, the processes and/or algorithms described herein in relation to FIGS. 11 and/or 12.

In one configuration, the apparatus 700 for wireless communication includes means for receiving a message conveying a TPC command to be, implemented at a plurality of cells and means for applying the TPC command to the plurality of cells. In one aspect, the aforementioned means may be processor 704 shown in FIG. 7 configured to perform the functions recited by the aforementioned means. In another aspect, the aforementioned means may be a circuit or any apparatus configured to perform the functions recited by the aforementioned means.

Of course, in the above examples, the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, and/or 3, and utilizing, for example, the processes and/or algorithms described herein in relation to FIGS. 13 and/or 14.

The following provides an overview of aspects of the present disclosure:

Aspect 1: A method of wireless communication, operational at a scheduling entity, comprising formatting a message to convey a transmitter power control (TPC) command to be implemented at a plurality of cells; and transmitting the message to a scheduled entity, wherein the TPC command includes a plurality of TPC values.

Aspect 2: The method of aspect 1, further comprising explicitly identifying each of the plurality of cells in the message.

Aspect 3: The method of aspect 1 or 2, further comprising applying a different one of the plurality of TPC values to each of the plurality of cells explicitly identified in the message.

Aspect 4: The method of any one of aspects 1 through 3, further comprising explicitly identifying each of the plurality of cells with a cell identifier (cell ID).

Aspect 5: The method of any one of aspects 1 through 4, further comprising applying a different one of the plurality of TPC values to each of the plurality of cells explicitly identified with a respective cell ID.

Aspect 6: The method of any one of aspects 1 through 5, further comprising, identifying each of the plurality of cells in a bitmap that divides the plurality of cells into subgroups that are each identified with a group identification (group ID).

Aspect 7: The method of any one of aspects 1 through 6, further comprising applying a different one of the plurality of TPC values to each respective group ID.

Aspect 8: The method of any one of aspects 1 through 7, wherein: the TPC command includes a TPC codepoint; the TPC codepoint is associated with a plurality of TPC values; and each of the plurality of TPC values is associated with a respective one of the plurality of cells.

Aspect 9: An apparatus for wireless communication, comprising: a processor; a transceiver communicatively coupled to the processor; and a memory communicatively coupled to the processor, wherein the memory and the processor are configured to perform a method of any one of claims 1 through 8.

Aspect 10: An apparatus for wireless communication comprising at least one means for performing a method of any one of aspects 1 through 8.

Aspect 11: A non-transitory computer-readable medium storing computer-executable code, comprising code for causing an apparatus for wireless communication to perform a method of any one of aspects 1 through 8.

Aspect 12: A method of wireless communication, operational at a scheduled entity, comprising receiving a message conveying a transmitter power control (TPC) command to be implemented at a plurality of cells; and applying the TPC command to the plurality of cells, wherein the TPC command includes a plurality of TPC values.

Aspect 13: The method of aspect 12, wherein the message explicitly identifies each of the plurality of cells.

Aspect 14: The method of aspect 12 or 13, further comprising applying the TPC command to the plurality of cells by applying a different one of the plurality of TPC values to each of the plurality of cells explicitly identified in the message.

Aspect 15: The method of any of aspects 12 through 14, wherein the message explicitly identifies each of the plurality of cells with a cell identifier (cell ID).

Aspect 16: The method of any of aspects 12 through 15, further comprising applying the TPC command to the plurality of cells by applying a different one of the plurality of TPC values to each of the plurality of cells explicitly identified with a respective cell ID.

Aspect 17: The method of any of aspects 12 through 16, wherein each of the plurality of cells is identified in a bitmap that divides the plurality of cells into subgroups that are each identified with a group identification (group ID).

Aspect 18: The method of any of aspects 12 through 17, further comprising applying the TPC command to the plurality of cells by applying a different one of the plurality of TPC values to each respective group ID.

Aspect 19: An apparatus for wireless communication, comprising: a processor; a transceiver communicatively coupled to the processor; and a memory communicatively coupled to the processor, wherein the memory and the processor are configured to perform a method of any one of claims 12 through 18,

Aspect 20: An apparatus for wireless communication comprising at least one means for performing a method of any one of aspects 12 through 18.

Aspect 21: A non-transitory computer-readable medium storing computer-executable code, comprising code for causing an apparatus for wireless communication to perform a method of any one of aspects 12 through 18.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO), Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system,

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-14 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-10 may be configured to perform one or more of the methods, features, or steps described herein, for example in connection with FIGS. 11-14. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may he rearranged. The accompanying method claims present elements of the various steps in a sample order and are not meant to be limited to the specific order or hierarchy presented unless specifically recited therein.

The previous description is provided to enable any person skilled the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims,

What is claimed is:

1. A method of wireless communication, operational at a scheduling entity, comprising:
formatting a message to convey a transmitter power control (TPC) command to be implemented at a plurality of cells; and
transmitting the message to a scheduled entity,
wherein the TPC command includes a plurality of TPC values.

2. The method of claim 1, further comprising explicitly identifying each of the plurality of cells in the message.

3. The method of claim 2, further comprising applying a different one of the plurality of TPC values to each of the plurality of cells explicitly identified in the message.

4. The method of claim 1, further comprising explicitly identifying each of the plurality of cells with a cell identifier (cell ID).

5. The method of claim 4, further comprising applying a different one of the plurality of TPC values to each of the plurality of cells explicitly identified with a respective cell ID.

6. The method of claim 1, further comprising, identifying each of the plurality of cells in a bitmap that divides the plurality of cells into subgroups that are each identified with a group identification (group ID).

7. The method of claim 6, further comprising applying a different one of the plurality of TPC values to each respective group ID.

8. The method of claim 1, wherein:
the TPC command includes a TPC codepoint;
the TPC codepoint is associated with a plurality of TPC values; and
each of the plurality of TPC values is associated with a respective one of he plurality of cells.

9. An apparatus for wireless communication, comprising:
a processor;
a transceiver communicatively coupled to the processor; and
a memory communicatively coupled to the processor,
wherein the processor is configured to:
format a message to convey a transmitter power control (TPC) command to be implemented at a plurality of cells, and
transmit the message to a scheduled entity,
wherein the TPC communication and includes a plurality of TPC values.

10. The apparatus of claim 9, wherein the processor is further configured to explicitly identify each of the plurality of cells in the message,

11. The apparatus of claim 10, wherein the processor is further configured to app different one of the plurality of TPC values to each of the plurality of cells explicitly identified in the message.

12. The apparatus of claim 9. wherein the processor is further configured to explicitly identify each of the plurality of cells with a cell identifier (cell ID).

13. The apparatus of claim 12, wherein the processor is further configured to apply a different one of the plurality of TPC values to each of the plurality of cells explicitly identified with a respective cell ID.

14. The apparatus of claim 9, wherein the processor is further configured to identify each of the plurality of cells in a bitmap that divides the plurality of cells into subgroups that are each identified with a group identification (group ID).

15. The apparatus of claim 14, wherein the processor is further configured to apply a different one of the plurality of TPC values to each respective group ID.

16. The apparatus of claim 9, wherein:
the TPC command includes a TPC codepoint;
the TPC codepoint is associated with a plurality of TPC values; and
each of the plurality of TPC values is associated with a respective one of the plurality of cells.

17. A method of wireless communication, operational at a scheduled entity, comprising:
receiving a message conveying a transmitter power control (TPC) command to be implemented at a plurality of cells; and
applying the TPC command to the plurality of cells,
wherein the TPC command includes a plurality of TPC values.

18. The method of claim 17, wherein the message explicitly identifies each of the plurality of cells.

19. The method of claim 18, further comprising applying the TPC command to the plurality of cells by applying a different one of the plurality of TPC values to each of the plurality of cells explicitly identified in the message.

20. The method of claim 17, wherein the message explicitly identifies each of the plurality of cells with a cell identifier (cell ID).

21. The method of claim 20, further comprising applying the TPC command to the plurality of cells by applying a different one of the plurality of TPC values to each of the plurality of cells explicitly identified with a respective cell ID.

22. The method of claim 17, wherein each of the plurality cells is identified in a bitmap that divides the plurality of cells into subgroups that are each identified with a group identification (group ID).

23. The method of claim 22, further comprising applying the TPC command to the plurality of cells by applying a different one of the plurality of TPC values to each respective group ID.

24. An apparatus for wireless communication, comprising:
a processor;
a transceiver communicatively coupled to the processor; and
a memory communicatively coupled to the processor, wherein the processor is configured to:
receive a message conveying a transmitter power control (TPC) command to be implemented at a plurality of cells, and
apply the TPC command to the plurality of cells,
wherein the TPC command includes a plurality of TPC values.

25. The apparatus of claim 24, wherein the message explicitly identifies each of the plurality of cells.

26. The apparatus of claim 25, wherein the processor is further configured to apply the TPC command to the plurality of cells by applying a. different one of the plurality of TPC values to each of the plurality of cells explicitly identified in the message.

27. The apparatus of claim 24, wherein the message explicitly identifies each of the plurality of cells with a cell identifier (cell ID).

28. The apparatus of claim 27, wherein the processor is further configured to apply the TPC command to the plurality of cells by applying a different one of the plurality of TPC values to each of the plurality of cells explicitly identified with a respective cell ID.

29. The apparatus of claim 24, wherein each of the plurality of cells is identified in a bitmap that divides the plurality of cells into subgroups that are each identified with a group identification (group ID).

30. The apparatus of claim 29, wherein the processor is further configured to apply the TPC command to the plurality of cells by applying a different one of the plurality of TPC values to each respective group ID.
